(19) United States
(12) Patent Application Publication
(10) Pub. No.: US 2003/0080621 A1
(43) Pub. Date: May 1, 2003

(54) Automotive electrical system protection device

(76) Inventor: John B. Kirk, Canfield, OH (US)

Correspondence Address: REISING ETHINGTON BARNES KISSELLE, LEARMAN AND MCCULLOCH PC, P O BOX 4390, TROY, MI, 48099-4390, US

(21) Appl. No.: 10/213,969

(22) Filed: Aug. 7, 2002

Related U.S. Application Data
(60) Provisional application No. 60/344,510, filed on Oct. 26, 2001.

(51) Int. Cl. H02H 7/18

(52) U.S. Cl. 307/10.7

(57) ABSTRACT

An automotive electrical system protection device protects the wiring of a direct current electrical system should a short circuit scenario occur. Moreover, the same protection device independently detects and guards again battery voltage depletion due to low current drain or run-down caused by faulty accessory loads or such loads being left on after the engine of the vehicle and associated generator are shut-off. The protection device has a run-down relay which opens upon prolonged low current conditions which causes battery voltage to deplete below a threshold voltage necessary to start the engine. Upon starting of the engine, the run-down relay, if open, will automatically close to permit power to the starter motor. During high current or short circuit conditions, a high current relay will open to protect the wiring of the electrical system including that of a primary conductor wired directly between the battery and the starter motor. The high current relay is protected by a fuse interposed to a secondary conductor connected across the high current relay. The fuse is sized and the opening of the high current relay is timed via a controller such that the fuse blows immediately after, and not before, the opening of the high current relay to provide a brief alternate path for high current flow.

### REFERENCE TO RELATED APPLICATION

Applicant claims the benefit of provisional application Serial No. 60/344,510, filed Oct. 26, 2001.

### TECHNICAL FIELD

The present invention relates to a direct current electrical system protection device and more particularly to a short circuit and run-down current automotive electrical system protection device for a motor vehicle.

### BACKGROUND OF THE INVENTION

Battery disconnect or electrical system protection devices for motor vehicles are known in which various electrical loads of the vehicle, other than the ignition switch or engine starter motor load, are automatically disconnected from the battery should a low current drain cause the battery voltage to drop below a threshold level needed to start the engine. For instance, U.S. Pat. No. 5,381,295, Rund, et al, discloses a latching relay which opens to preserve battery voltage for engine cranking by monitoring the battery voltage in case of low current drain. The Rund, '899 electronics are further capable of detecting exaggerated or sharp voltage drop levels which would indirectly indicate a short therefore a high current drain rate. Under such a high current scenario, the same latching relay will open to preserve battery voltage. Unfortunately, the device does not protect the system wiring from excessive current damage, nor does it protect the relay from high current arcing.

Yet another U.S. Pat. No. 6,049,140 Alsknat, et al, utilizes a hall or current sensor capable of detecting a short-circuit condition which will then open a switch, however, a means to protect the battery from low current drain is not provided, nor is a means provided to protect the switch from high current arcing.

Unfortunately, known battery protection devices preserve or protect battery voltage level but typically do not protect the electrical system of an automotive vehicle as a whole. Often, high current arcing at protection device relays will lead to damage of the protection device itself. For instance, known devices are not capable of protecting the switch or relays from high current arcing conditions should a short circuit occur. Furthermore, known devices which protect battery voltage from low current drain can not handle the normal high current operating spikes of a starter motor and thus do not protect the high current conductor or wire which provides power directly from the battery to the starter motor

### SUMMARY OF THE INVENTION

An automotive electrical system protection device protects the wiring of a direct current electrical system should a short circuit scenario occur. Moreover, the same protection device independently detects and guards again battery voltage depletion due to low current drain or run-down caused by faulty accessory loads or such loads being left on after the engine of the vehicle and associated generator are shut-off. The protection device has a run-down relay which opens upon prolonged low current conditions which causes battery voltage to deplete below a threshold voltage necessary to start the engine. Upon starting of the engine, the run-down relay, if open, automatically closes to permit power to the starter motor. During high current or short circuit conditions, a high current relay opens to protect the wiring of the electrical system including that of a primary conductor wired directly between the battery and the starter motor. The high current relay is protected by a fuse interposed to a secondary conductor connected across the high current relay. The fuse is sized and the opening of the high current relay is timed via a controller such that the fuse blows immediately after, and not before, the opening of the high current relay to provide a brief alternate path for high current flow.

Aside from the starter motor, other electrical accessory loads typically found in an automotive vehicle such as lights, wipers, power seats, etc., are also powered by the battery. Faults within these accessory loads can lead to the slow battery drain or short circuits which can harm the battery and cause electrical system damage. The automotive electrical system protection device guards against short circuit scenarios and run-down battery voltage drain via the run-down relay to protect against run-down battery drain thereby assuring a minimum voltage for the starter motor to operate and the high current relay to protect against short circuit conditions thereby isolating the accessory loads and the start motor from the battery. The high current relay is preferably a latching relay or a spring loaded mechanical reset switch which is protected from high current arcing by the fuse which blows soon after the opening of the high current relay. Electronics or a controller controls the sequencing and opening of the high current relays and run-down relay.

Advantages and features of the present invention includes an automatic re-settable protection device which assures enough power remains in the battery to start an engine in case of faulty electrical system loads or operator error, and protects the battery and electrical wires of the system including the high current wire leading directly from the battery to the starter motor. Yet another advantage of the present invention is a protection device which can repeatably operate without requiring maintenance intervention, is simple in design and inexpensive and easy to install.

### BRIEF DESCRIPTION OF THE DRAWINGS

The present invention will now be described, by way of example, with reference to the accompanying drawings, in which:

FIG. 1 is a schematic circuit diagram of the present invention; and

FIG. 2 is a schematic circuit diagram of a second embodiment of the present invention.

### DETAILED DESCRIPTION OF THE PREFERRED EMBODIMENTS

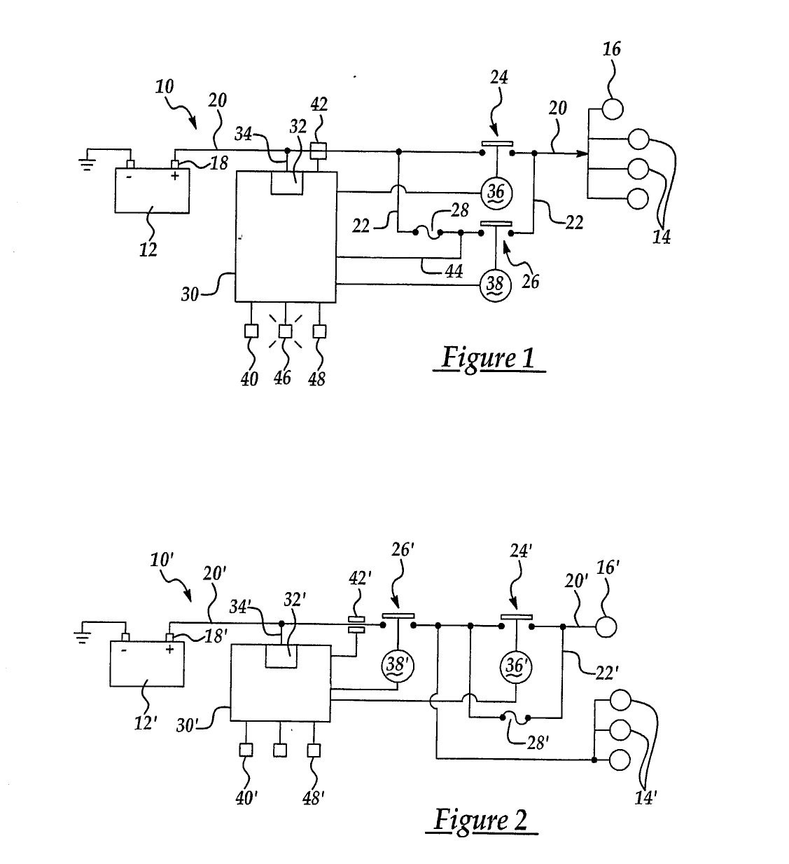

Referring now to the drawings, FIG. 1 illustrates an automotive electrical system protection device 10, specially designed to both protect against damage to electrical system wiring from excessive direct currents produced by potential short circuits and to guard a battery 12 against voltage depletion produced by low current run-down conditions. The automotive electrical system protection device 10 is preferably utilized in an automotive vehicle environment, and is engaged electrically between the battery 12 of the vehicle and a wide variety of accessory loads 14 including an engine starter motor 16. The low current run-down leading to a battery voltage depletion condition may be caused by any number of scenarios including faulty accessories or operator error. For example, the operator may leave the head lights on when the vehicle is parked and the engine is off. The protection device 10 will assure the battery 12 has sufficient voltage to start the engine.

The automotive electrical system protection device is directly connected electrically to a positive pole 18 of the car battery 12, or is interposed to a primary conductor 20 of the electrical system which is capable of handling the high peak currents of the starter 16. Typically starters for a twelve volt system will draw peak current in excess of 1200 amps. The primary conductor 20 is connected directly to the positive pole 18. The automotive electrical system protection device 10 is normally closed to allow current flow to the accessory loads 14 of the automotive vehicle and will independently detect two case scenarios. The first scenario being a short circuit condition which includes the primary conductor 20 that directly connects the starter 16 to the positive pole 18 of the battery 12, and the second scenario is a low current condition which is so prolonged that the battery voltage is in danger of depletion. The protection device 10 will react independently to either condition and activate respective relays accordingly.

Short circuit conditions create high currents which must be stopped early to prevent wire failure within the electrical system including that of the primary conductor 20. Under run-down conditions, very low currents cause drain upon the battery 12 which can potentially cause the battery's threshold voltage levels to fall below that which can start the engine via the starter motor 16. Thus, the automotive electrical system protection device 10 must be capable of handling generally all of the current from the battery 12 created by the accessory loads 14 and the starter motor 16. That is, the device 10 must be capable of repeatedly opening and closing under very high currents without incurring damage by high energy arcing. In the first embodiment of the present invention, under the run-down current scenario, the automotive electrical system protection device 10 is capable of opening an indefinite number of times during the life of the vehicle, while under short circuit scenarios the automotive electrical system protection device 10 is capable of opening less but still many times during the life of the vehicle.

The primary conductor 20 is interposed by or integrated to the automotive electrical system protection device 10 and is engaged between the positive pole 18 of the battery 12 and both the starter motor 16 and accessory loads 14. A secondary conductor 22 of the protection device 10 is engaged electrically across a high current or short circuit relay 24 interposing the primary conductor 20. The secondary conductor 22 is interposed by a run-down relay 26 which is thus oriented in series with the high current relay 24. An approximate thirty amp fuse 28 interposes the secondary conductor between the positive battery pole 18 and the run-down relay 26, thus the fuse 28 is wired in series to the run-down relay 26 and is parallel to the high current relay 24.

Electronics or a controller 30 of the protection device 10 controls the relays 24, 26 and operates off of a temporary power source 32 (i.e. a combination of capacitors and diodes) initially fed by the battery 12. During normal operating conditions, the controller is powered directly by the battery 12 via a conductor 34 engaged to the positive pole 18 or primary conductor 20 before the fuse 28 and high current relay 24. The controller 30 is thus not protected by the relays 24, 26. During controller operation, the controller 30 monitors battery voltage and will open the run-down relay 26 and high current relay 24 if battery voltage drops below a predetermined threshold level required to start the engine. The controller is not protected by the relays because it must be able to detect an attempted start of the engine to automatically close the relays 24, 26 after a battery voltage depletions scenario which would have opened them.

The relays 24, 26 are preferably of a latching type or any other switch which only requires power to actuate open and actuate closed. That is, respective coils 36, 38 of the relays 24, 26 are only energized briefly during actuation. This will preserve battery power and enable the controller 30 to temporarily operate the relays 24, 26 via stored capacitor energy even if the battery voltage is depleted. When battery voltage level is restored or an enable signal is received by the turning of the ignition switch 40 to start the engine, the controller 30 will automatically close the latching relays 24, 26, restoring power to the accessory loads 14 and starter motor 16. Closure of the relays 24, 26 need not be automatic and can be manual in the form of a spring loaded reset switch or some other form of circuit breaker.

A voltage or current sensor 42 provides the signal to the controller 10 for the detection of an excessively high current scenario, substantially above 1200 amps in a twelve volt system. If a voltage sensor is utilized, a sharp drop in voltage across the primary conductor is indicative of a high current in the primary conductor 20. Regardless, once a pre-determined high current is detected via the sensor 42, the controller opens the high current relay 24, and the run-down relay 26 remains closed. The fuse 28, which is preferably a manual fuse of approximately thirty amps, is sized to blow immediately after the high current relay 24 opens, by about twenty milliseconds. Sequencing of the fuse 28 protects the high current relay 24 from high current arcing by providing a very brief current path through the secondary conductor 22. This is accomplished by timing or sequencing within the electronics of the controller 30 and proper sizing of the manual fuse 28.

After the short circuit fault is repaired, or the high current condition removed, and after the blown manual fuse 28 is replaced, the controller 30 will receive an enable signal to automatically close the high current relay 24. The enable signal is delivered by an enable wire 44 of the controller 30 which is engaged electrically to the secondary conductor 22 between the fuse 28 and the run-down relay 26. Thus, and as a cautionary or safety measure, the fuse 28 must be replaced before the controller 30 will close the high current relay 24, restoring the system. The controller 30 can also initiate a “fuse blown” warning light or indicator 46 via the signal sent through the enable wire 44.

Referring to FIG. 2, a second embodiment of the present invention is illustrated. Similar to the first embodiment, the second embodiment has a run-down relay 26′ and a high current relay 24′ both preferably of a latching type, and a manual fuse 28′ to protect the high current relay 24′ from high energy electrical arcing. However, contrary to the first embodiment, the run-down relay 26′ is interposed to the primary conductor 20′ between the positive pole 18′ of the battery 12′ and the high current relay 24′ so that the run-down relay 26′ is orientated in series to the high current relay 24′. Like the first embodiment, the manual fuse 28′ is interposed to a secondary conductor 22′ connected across the high current relay 24′, but not connected across the run-down relay 26′. During operation, under high current conditions, the fuse 28′, which is approximately ten amps for a twelve volt system, protects the high current relay 24′ when opening for approximately twenty milliseconds by providing a parallel path through the secondary conductor 22′ for high current. During run-down current conditions, the run-down relay 26′ will open, however, unlike the first embodiment, the high current relay 24′ remains closed. The accessory or auxiliary loads 14′ draw power from the primary conductor 20′ between the relays 24′, 26′, so that if the high current relay 24′ is open, the accessory loads 14′ will still be powered even though the starter motor 16′ will not be powered.

The controller 30 in the first embodiment may also open both relays 24, 26, or the controller 30′ in the second embodiment may open just the run-down relay 26′, upon receipt of a signal indicating any other desired scenario such as theft detection, air bag initiation, and vehicle roll over, receiving a signal from sensor 48 or 48′.

While the forms of the invention herein disclosed constitute presently preferred embodiments many others are possible. It is not intended herein to mention all the possible equivalent forms or ramifications of the invention. It is understood that the terms used here are merely descriptive rather than limiting and various changes may be made without departing from the spirit or scope of the invention.

1. An automotive electrical system protection device for an electrical system of an automotive vehicle having a starter motor and other electrical accessory loads, a battery having a threshold voltage below which the starter motor will not operate, the automotive electrical system protection device comprising:
a primary conductor connected directly between a positive pole of the battery and the accessory loads;
a normally closed run-down relay connected electrically to the primary conductor;
a normally closed high current relay interposed to the primary conductor;
a secondary conductor connected directly across the high current relay;
a fuse interposed to the secondary conductor so that the fuse is orientated electrically in parallel to the high current relay;
wherein under high current conditions, the fuse protects the high current relay from high current arcing by opening immediately after the high current relay opens; and
wherein under run-down current conditions and when the battery threshold voltage is reached, the run-down relay opens.

2. The automotive electrical system protection device set forth in claim 1 wherein the fuse is a manual fuse which blows to open the secondary conductor.

3. The automotive electrical system protection device set forth in claim 2 wherein the high current relay is a latching relay.

4. The automotive electrical system protection device set forth in claim 3 comprising a controller constructed and arranged to open the run-down relay and the high current relay.

5. The automotive electrical system protection device set forth in claim 4 wherein the high current and run-down relays have respective first and second electric coils energized by the controller.

6. The automotive electrical system protection device set forth in claim 1 wherein the run-down relay is connected electrically in parallel to the high current relay, and wherein the high current relay opens when the battery threshold voltage is reached during run-down current conditions.

7. The automotive electrical system protection device set forth in claim 6 wherein the run-down current relay is interposed to the secondary conductor and orientated electrically in series with the fuse.

8. The automotive electrical system protection device set forth in claim 7 wherein the fuse is engaged electrically before the run-down current relay.

9. The automotive electrical system protection device set forth in claim 8 comprising an enable wire engaged to the secondary conductor after the fuse to transmit an enable signal to the controller.

10. The automotive electrical system protection device set forth in claim 9 comprising a blown fuse warning indicator which initiates via the controller and the enable wire, and wherein the fuse is a manual fuse.

11. The automotive electrical system protection device set forth in claim 6 wherein the relays are orientated electrically before the starter motor and accessory loads.

12. The automotive electrical system protection device set forth in claim 1 wherein the run-down current relay is interposed to the primary conductor before the high current relay so that the run-down current relay is orientated in series with the high current relay.

13. The automotive electrical system protection device set forth in claim 12 wherein the run-down relay is a latching relay.

14. The automotive electrical system protection device set forth in claim 13 wherein the high current relay is a latching relay.

15. The automotive electrical system protection device set forth in claim 13 wherein the high current relay is a spring loaded manual reset switch.

16. The automotive electrical system protection device set forth in claim 12 comprising a controller constructed and arranged to open the run-down and high current relays.

17. The automotive electrical system protection device set forth in claim 16 comprising a short circuit detector constructed and arranged to measure current at the primary conductor before the run-down relay and communicate with the controller.

18. The automotive electrical system protection device set forth in claim 17 wherein the starter motor is engaged electrically to the primary conductor after the high current relay
